(19) United States
(12) Patent Application Publication
(10) Pub. No.: US 2025/0211838 A1
(43) Pub. Date: Jun. 26, 2025

(54) THERMAL IMAGING AND WIRELESS COMMUNICATION SYSTEMS AND METHODS

(71) Applicant: Teledyne FLIR Commercial Systems, Inc., Goleta, CA (US)

(72) Inventors: Ryan M. Stevenson, Santa Barbara, CA (US); Nile E. Fairfield, Goleta, CA (US); Kelsey M. Judd, Santa Barbara, CA (US); Eiichi T. Takagi, Goleta, CA (US); Chris J. Posch, Santa Barbara, CA (US)

(21) Appl. No.: 19/076,890

(22) Filed: Mar. 11, 2025

Related U.S. Application Data
(63) Continuation of application No. PCT/US2023/074108, filed on Sep. 13, 2023.
(60) Provisional application No. 63/406,672, filed on Sep. 14, 2022.

(51) Int. Cl. H04N 23/23; H04N 5/33

(52) U.S. Cl. CPC H04N 23/23; H04N 5/33

(57) ABSTRACT

Techniques are disclosed for providing thermal imaging and wireless communication systems and methods. In one example, a thermal imaging system includes a thermal imaging device configured to capture thermal image data associated with a scene, generate user-viewable thermal images based on the thermal image data, and wirelessly transmit data indicative of the user-viewable thermal images. The thermal imaging system further includes a receiver device configured to receive the data from the thermal imaging device and transmit the data to a user device. Related methods, vehicles, and devices are also provided.

### CROSS REFERENCE TO RELATED APPLICATIONS

This application is a continuation of International Patent Application No. PCT/US2023/074108 filed Sep. 13, 2023 and entitled “THERMAL IMAGING AND WIRELESS COMMUNICATION SYSTEMS AND METHODS,” which claims priority to and the benefit of U.S. Provisional Patent Application No. 63/406,672 filed Sep. 14, 2022 and entitled “THERMAL IMAGING AND WIRELESS COMMUNICATION SYSTEMS AND METHODS,” all of which are incorporated herein by reference in their entirety.

### TECHNICAL FIELD

One or more embodiments relate generally to imaging and more particularly, for example, to thermal imaging and wireless communication systems and methods.

### BACKGROUND

Imaging systems may include an array of detectors, with each detector functioning as a pixel to produce a portion of a two-dimensional image. There are a wide variety of image detectors, such as visible-light image detectors, infrared image detectors, or other types of image detectors that may be provided in an image detector array for capturing an image. As an example, a plurality of sensors may be provided in an image detector array to detect electromagnetic (EM) radiation at desired wavelengths. In some cases, such as for infrared imaging, readout of image data captured by the detectors may be performed in a time-multiplexed manner by a readout integrated circuit (ROIC). The image data that is read out may be communicated to other circuitry, such as for processing, storage, and/or display. In some cases, a combination of a detector array and an ROIC may be referred to as a focal plane array (FPA). Advances in process technology for FPAs and image processing have led to increased capabilities and sophistication of resulting imaging systems.

### SUMMARY

In one or more embodiments, a thermal imaging system includes a thermal imaging device configured to capture thermal image data associated with a scene, generate user-viewable thermal images based on the thermal image data, and wirelessly transmit data indicative of the user-viewable thermal images. The thermal imaging system further includes a receiver device configured to receive the data from the thermal imaging device and transmit the data to a user device.

In one or more embodiments, a method includes capturing, by a thermal imaging device, thermal image data associated with a scene. The method further includes generating, by the thermal imaging device, user-viewable thermal images based on the thermal image data. The method further includes wirelessly transmitting, by the thermal imaging device, data indicative of the user-viewable thermal images. The method further includes receiving, by a receiver device, the data from the thermal imaging device. The method further includes transmitting, by the receiver device, the data to a user device.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates a block diagram of an example imaging system in accordance with one or more embodiments of the present disclosure.

FIG. 2 illustrates a block diagram of an example image sensor assembly in accordance with one or more embodiments of the present disclosure.

FIG. 3 illustrates a block diagram of an example thermal imaging system in accordance with one or more embodiments of the present disclosure.

FIG. 4A illustrates an example system for facilitating thermal imaging and wireless communication in accordance with one or more embodiments of the present disclosure.

FIG. 4B illustrates a zoomed-out view that illustrates a vehicle and a portion of the system FIG. 4A exterior to the vehicle.

FIG. 5 illustrates a block diagram of an example system for facilitating thermal imaging and wireless communication in accordance with one or more embodiments of the present disclosure.

FIG. 6 illustrates a flow diagram of an example process for facilitating thermal imaging and wireless communication in accordance with one or more embodiments of the present disclosure.

Embodiments of the present disclosure and their advantages are best understood by referring to the detailed description that follows. It is noted that sizes of various components and distances between these components are not drawn to scale in the figures. It should be appreciated that like reference numerals are used to identify like elements illustrated in one or more of the figures.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

Various embodiments for thermal imaging and wireless communication systems and methods are provided herein. In some embodiments, a thermal imaging system includes a thermal imaging device and a receiver device. The thermal imaging device may capture thermal image data, generate user-viewable thermal images (e.g., thermograms) based on the thermal image data, and transmit the user-viewable thermal images to the receiver device. The user-viewable thermal images may be visible-light representations of the captured thermal image data. The receiver device in turn may relay (e.g., direct) the user-viewable thermal images to a user device (e.g., a smartphone, a tablet, a laptop) to allow a user to readily view the user-viewable thermal images.

The thermal imaging device may include an image capture device (e.g., a thermal camera core) for capturing infrared (IR) image data (e.g., thermal infrared image data), a processing component for generating user-viewable thermal images based on the infrared image data, a communication device for transmitting the infrared image data and/or the user-viewable thermal images, and a power control device (e.g., also referred to as a power management device or a power regulation device) for receiving and distributing power to operate the thermal imaging device. In some cases, the power control device may receive power wirelessly (e.g., via inductive power transfer, capacitive power transfer, and/or other wireless power transfer) from the receiver device. In some cases, the communication device and the power control device may be performed using one or more printed circuit board assemblies (PCBAs).

In some embodiments, the thermal imaging system may be used in vehicular applications. The thermal imaging device is mounted on an external surface of a vehicle and the receiver device is mounted to an interior surface of the vehicle or positioned inside the vehicle. In this regard, to facilitate thermal imaging, the thermal imaging device is positioned external to the vehicle since glass has low transmittance for various infrared wavebands and thus a thermal imaging device positioned within the vehicle is generally associated with lower image quality. As an example, a housing of the thermal imaging device may be mounted on an exterior surface of a front windshield of a vehicle. The thermal imaging device may capture video data and wirelessly transmit/stream user-viewable thermal images generated based on the video data through a windshield to one or more devices, such as the receiver device, having a processing and/or video display assembly inside a cabin of the vehicle. The receiver device may then stream that video data to the user device and/or other device(s). In some cases, a visible-light camera may be within the housing. In such cases, the thermal imaging device may perform sensor fusion of visible-light image data and thermal image data.

The housing may be formed of an appropriate material, size, and shape to effectuate desired mechanical characteristics/properties (e.g., aerodynamic properties, shock/vibe properties, waterproofing, etc.), which for vehicular applications include characteristics/properties to facilitate high volume manufacturing and automotive environmental specifications. For vehicular applications, a design of the thermal imaging device (e.g., its housing and components therein) may involve testing using thermal analysis to show that the thermal imaging device can meet the stringent requirements of an exterior mounted vehicle safety accessory.

Although the present disclosure is described primarily in relation to a thermal imaging system provided on and within a terrestrial vehicle (e.g., car with an imaging device mounted on an external surface of the car and a receiver device positioned in an interior of the car), the imaging system may similarly be provided on and within an airborne vehicle, a marine vehicle, a building (e.g., for surveillance), and generally any structure/device having an exterior for positioning the imaging device and an interior for positioning the receiver device. In some cases, the imaging system may be used in driver-assistance systems, such as advanced driver-assistance systems (ADAS) and automatic emergency braking (AEB) systems, with the thermal imaging functionality of the imaging system able to promote road safety during both daytime and nighttime. As non-limiting examples, thermal imaging may be used to facilitate night vision and vision through difficult lighting scenarios like sun glare and fog.

Using various embodiments, the thermal imaging system provides thermal imaging capability to a vehicle as part of an automotive aftermarket. In this regard, the thermal imaging system may be installed without any penetration of the vehicle, such as penetration of any glass, metal, and/or other material of the vehicle. The thermal imaging system may be releasably coupled to and/or removably positioned in or on a vehicle. The thermal imaging system may transfer video data (e.g., streams video data), power, and command/control signals between the thermal imaging device (e.g., positioned externally) and one or more interior devices. Such communication between the thermal imaging device to one or more receiver devices may be performed without physical cables and connectors between the thermal imaging device and the receiver device(s). Compactness of the thermal imaging system may allow ready integrate with other ADAS and AEB sensors on board the vehicle. In some cases, transceiver-on-chip technology is used to establish a data link. Such transceiver-on-chip technology may be used to facilitate compact circuit board implementations. In some cases, the transceiver-on-chip technology may be used for short-range (e.g., a few centimeters, such as less than 10 cm). In this regard, in some cases, the thermal imaging device and the receiver device(s) may be appropriately positioned relative to each other to utilize the short-range communication. The receiver device(s) may then be utilized for longer range communication with one or more user devices. The transceiver-on-chip technology may be leveraged to design and implement interface cables and microprocessor code and tested on evaluations cards.

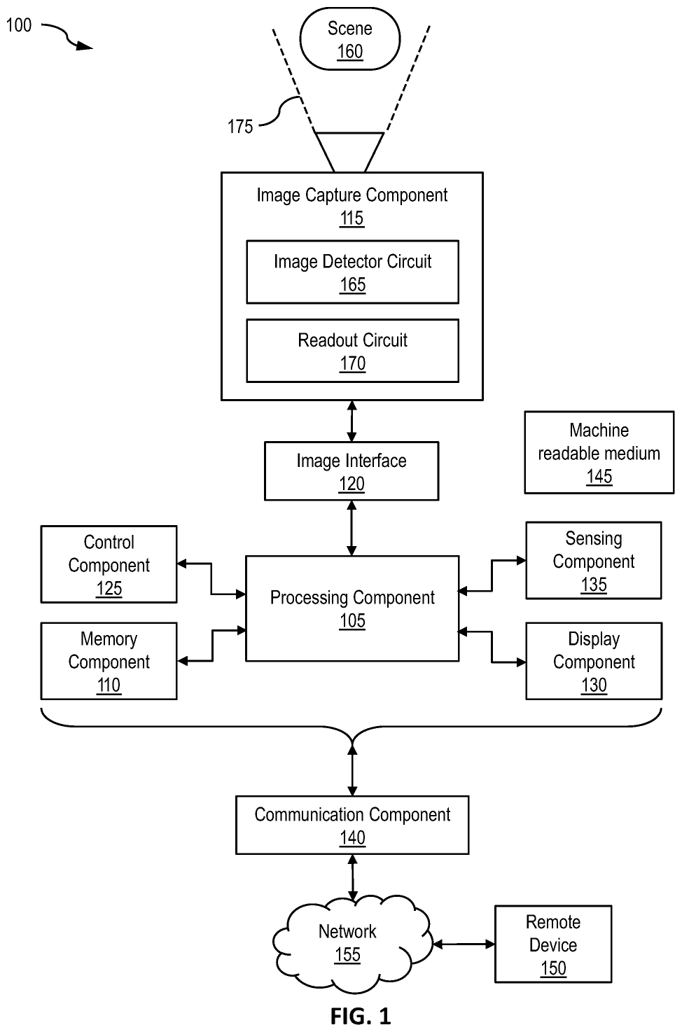

Referring now to the drawings, FIG. 1 illustrates a block diagram of an example imaging system 100 in accordance with one or more embodiments of the present disclosure. Not all of the depicted components may be required, however, and one or more embodiments may include additional components not shown in the figure. Variations in the arrangement and type of the components may be made without departing from the spirit or scope of the claims as set forth herein. Additional components, different components, and/or fewer components may be provided.

The imaging system 100 may be utilized for capturing and processing images in accordance with an embodiment of the disclosure. The imaging system 100 may represent any type of imaging system that detects one or more ranges (e.g., wavebands) of EM radiation and provides representative data (e.g., one or more still image frames or video image frames). In some embodiments, the imaging system 100 may include one or more housings that at least partially encloses one or more components of the imaging system 100, such as to facilitate compactness and protection of the imaging system 100. For example, the solid box labeled 100 in FIG. 1 may represent the housing of the imaging system 100. The housing may contain more, fewer, and/or different components of the imaging system 100 than those depicted within the solid box in FIG. 1. In other embodiments, one or more components of the imaging system 100 may be implemented remotely from each other in a distributed fashion (e.g., networked or otherwise). In an embodiment, the imaging system 100 (or components thereof) may include a portable device and may be incorporated (e.g., mounted), for example, into a land-based vehicle. By way of non-limiting examples, the vehicle may be a land-based vehicle (e.g., automobile, truck, etc.), a naval-based vehicle, an aerial vehicle (e.g., manned aerial vehicle, UAV), a space vehicle, or generally any type of vehicle that may incorporate (e.g., installed within, mounted thereon, etc.) the imaging system 100.

The imaging system 100 includes, according to one implementation, a processing component 105, a memory component 110, an image capture component 115, an image interface 120, a control component 125, a display component 130, a sensing component 135, and a communication component 140. The processing component 105, according to various embodiments, includes one or more of a processor, a microprocessor, a central processing unit (CPU), a graphics processing unit (GPU), a single-core processor, a multi-core processor, a microcontroller, a programmable logic device (PLD) (e.g., field programmable gate array (FPGA)), an application specific integrated circuit (ASIC), a digital signal processing (DSP) device, or other logic device that may be configured, by hardwiring, executing software instructions, or a combination of both, to perform various operations discussed herein for embodiments of the disclosure. The processing component 105 may be configured to interface and communicate with the various other components (e.g., 110, 115, 120, 125, 130, 135, 140, etc.) of the imaging system 100 to perform such operations. For example, the processing component 105 may be configured to process captured image data received from the image capture component 115, store the image data in the memory component 110, and/or retrieve stored image data from the memory component 110. In one aspect, the processing component 105 may be configured to perform various system control operations (e.g., to control communications and operations of various components of the imaging system 100) and other image processing operations (e.g., data conversion, video analytics, etc.).

In some embodiments, the processing component 105 may perform operations to facilitate calibration of the image capture component 115 (e.g., sensors of the image capture component 115). In one case, the processing component 105 may generate calibration data (e.g., one or more correction values) based on an image of a scene 160 from the image capture component 115 and/or apply the calibration data to the image (e.g., pixel values of the image) captured by the image capture component 115. In some cases, the processing component 105 may perform operations such as non-uniformity correction (NUC) (e.g., flat field correction (FFC) or other calibration technique), spatial and/or temporal filtering, and/or radiometric conversion on the pixel values.

The memory component 110 includes, in one embodiment, one or more memory devices configured to store data and information, including infrared image data and information. The memory component 110 may include one or more various types of memory devices including volatile and non-volatile memory devices, such as random access memory (RAM), dynamic RAM (DRAM), static RAM (SRAM), non-volatile random-access memory (NVRAM), read-only memory (ROM), programmable read-only memory (PROM), erasable programmable read-only memory (EPROM), electrically-erasable programmable read-only memory (EEPROM), flash memory, hard disk drive, and/or other types of memory. As discussed above, the processing component 105 may be configured to execute software instructions stored in the memory component 110 so as to perform method and process steps and/or operations. The processing component 105 and/or the image interface 120 may be configured to store in the memory component 110 images or digital image data captured by the image capture component 115 and/or correction values (e.g., determined from calibration). The processing component 105 may be configured to store processed still and/or video images in the memory component 110.

In some embodiments, a separate machine-readable medium 145 (e.g., a memory, such as a hard drive, a compact disk, a digital video disk, or a flash memory) may store the software instructions and/or configuration data which can be executed or accessed by a computer (e.g., a logic device or processor-based system) to perform various methods and operations, such as methods and operations associated with processing image data. In one aspect, the machine-readable medium 145 may be portable and/or located separate from the imaging system 100, with the stored software instructions and/or data provided to the imaging system 100 by coupling the machine-readable medium 145 to the imaging system 100 and/or by the imaging system 100 downloading (e.g., via a wired link and/or a wireless link) from the machine-readable medium 145. It should be appreciated that various modules may be integrated in software and/or hardware as part of the processing component 105, with code (e.g., software or configuration data) for the modules stored, for example, in the memory component 110.

The imaging system 100 may represent an imaging device, such as a video and/or still camera, to capture and process images and/or videos of the scene 160. In this regard, the image capture component 115 of the imaging system 100 may be configured to capture images (e.g., still and/or video images) of the scene 160 in a particular spectrum or modality. The image capture component 115 has a field of view (FOV) 175. In an embodiment, the image capture component 115 is mounted on a vehicle to capture images (e.g., thermal images) of the scene 160. The image capture component 115 includes an image detector circuit 165 (e.g., a thermal infrared detector circuit) and a readout circuit 170 (e.g., an ROIC). For example, the image capture component 115 may include an IR imaging sensor (e.g., IR imaging sensor array) configured to detect IR radiation in the near, middle, and/or far IR spectrum and provide IR images (e.g., IR image data or signal) representative of the IR radiation from the scene 160. For example, the image detector circuit 165 may capture (e.g., detect, sense) IR radiation with wavelengths in the range from around 700 nm to around 2 mm, or portion thereof. For example, in some aspects, the image detector circuit 165 may be sensitive to (e.g., better detect) short-wave IR (SWIR) radiation, mid-wave IR (MWIR) radiation (e.g., EM radiation with wavelength of 2-5 μm) and/or long-wave IR (LWIR) radiation (e.g., EM radiation with wavelength of 7-14 μm), or any desired IR wavelengths (e.g., generally in the 0.7 to 14 μm range). In other aspects, the image detector circuit 165 may capture radiation from one or more other wavebands of the EM spectrum, such as visible-light, ultraviolet light, and so forth.

The image detector circuit 165 may capture image data associated with the scene 160. To capture the image, the image detector circuit 165 may detect image data of the scene 160 (e.g., in the form of EM radiation) and generate pixel values of the image based on the scene 160. An image may be referred to as a frame or an image frame. In some cases, the image detector circuit 165 may include an array of detectors (e.g., also referred to as an array of sensors or an array of pixels) that can detect radiation of a certain waveband, convert the detected radiation into electrical signals (e.g., voltages, currents, etc.), and generate the pixel values based on the electrical signals. Each detector in the array may capture a respective portion of the image data and generate a pixel value based on the respective portion captured by the detector. The pixel value generated by the detector may be referred to as an output of the detector. By way of non-limiting examples, each detector may be a photodetector, such as an avalanche photodiode, an infrared photodetector, a quantum well infrared photodetector, a microbolometer, or other detector capable of converting EM radiation (e.g., of a certain wavelength) to a pixel value. The array of detectors may be arranged in rows and columns.

The image may be, or may be considered, a data structure that includes pixels and is a representation of the image data associated with the scene 160, with each pixel having a pixel value that represents EM radiation emitted or reflected from a portion of the scene 160 and received by a detector that generates the pixel value. Based on context, a pixel may refer to a detector of the image detector circuit 165 that generates an associated pixel value or a pixel (e.g., pixel location, pixel coordinate) of the image formed from the generated pixel values.

In an aspect, the pixel values generated by the image detector circuit 165 may be represented in terms of digital count values generated based on the electrical signals obtained from converting the detected radiation. For example, in a case that the image detector circuit 165 includes or is otherwise coupled to an analog-to-digital converter (ADC) circuit, the ADC circuit may generate digital count values based on the electrical signals. For an ADC circuit that can represent an electrical signal using 14 bits, the digital count value may range from 0 to 16,383. In such cases, the pixel value of the detector may be the digital count value output from the ADC circuit. In other cases (e.g., in cases without an ADC circuit), the pixel value may be analog in nature with a value that is, or is indicative of, the value of the electrical signal. As an example, for infrared imaging, a larger amount of IR radiation being incident on and detected by the image detector circuit 165 (e.g., an IR image detector circuit) is associated with higher digital count values and higher temperatures.

The readout circuit 170 may be utilized as an interface between the image detector circuit 165 that detects the image data and the processing component 105 that processes the detected image data as read out by the readout circuit 170, with communication of data from the readout circuit 170 to the processing component 105 facilitated by the image interface 120. An image capturing frame rate may refer to the rate (e.g., images per second) at which images are detected in a sequence by the image detector circuit 165 and provided to the processing component 105 by the readout circuit 170. The readout circuit 170 may read out the pixel values generated by the image detector circuit 165 in accordance with an integration time (e.g., also referred to as an integration period).

In various embodiments, a combination of the image detector circuit 165 and the readout circuit 170 may be, may include, or may together provide an FPA. In some aspects, the image detector circuit 165 may be a thermal image detector circuit that includes an array of microbolometers, and the combination of the image detector circuit 165 and the readout circuit 180 may be referred to as a microbolometer FPA. In some cases, the array of microbolometers may be arranged in rows and columns. The microbolometers may detect IR radiation and generate pixel values based on the detected IR radiation. For example, in some cases, the microbolometers may be thermal IR detectors that detect IR radiation in the form of heat energy and generate pixel values based on the amount of heat energy detected. The microbolometer FPA may include IR detecting materials such as amorphous silicon (a-Si), vanadium oxide (VOₓ), a combination thereof, and/or other detecting material(s). In an aspect, for a microbolometer FPA, the integration time may be, or may be indicative of, a time interval during which the microbolometers are biased. In this case, a longer integration time may be associated with higher gain of the IR signal, but not more IR radiation being collected. The IR radiation may be collected in the form of heat energy by the microbolometers.

In some cases, the image capture component 115 may include one or more filters adapted to pass radiation of some wavelengths but substantially block radiation of other wavelengths. For example, the image capture component 115 may be an IR imaging device that includes one or more filters adapted to pass IR radiation of some wavelengths while substantially blocking IR radiation of other wavelengths (e.g., MWIR filters, thermal IR filters, and narrow-band filters). In this example, such filters may be utilized to tailor the image capture component 115 for increased sensitivity to a desired band of IR wavelengths. In an aspect, an IR imaging device may be referred to as a thermal imaging device when the IR imaging device is tailored for capturing thermal IR images. Other imaging devices, including IR imaging devices tailored for capturing infrared IR images outside the thermal range, may be referred to as non-thermal imaging devices.

In one specific, not-limiting example, the image capture component 115 may include an IR imaging sensor having an FPA of detectors responsive to IR radiation including near infrared (NIR), SWIR, MWIR, LWIR, and/or very-long wave IR (VLWIR) radiation. In some other embodiments, alternatively or in addition, the image capture component 115 may include a complementary metal oxide semiconductor (CMOS) sensor or a charge-coupled device (CCD) sensor that can be found in any consumer camera (e.g., visible light camera).

Other imaging sensors that may be embodied in the image capture component 115 include a photonic mixer device (PMD) imaging sensor or other time of flight (ToF) imaging sensor, light detection and ranging (LIDAR) imaging device, millimeter imaging device, positron emission tomography (PET) scanner, single photon emission computed tomography (SPECT) scanner, ultrasonic imaging device, or other imaging devices operating in particular modalities and/or spectra. It is noted that for some of these imaging sensors that are configured to capture images in particular modalities and/or spectra (e.g., infrared spectrum, etc.), they are more prone to produce images with low frequency shading, for example, when compared with a typical CMOS-based or CCD-based imaging sensors or other imaging sensors, imaging scanners, or imaging devices of different modalities.

The images, or the digital image data corresponding to the images, provided by the image capture component 115 may be associated with respective image dimensions (also referred to as pixel dimensions). An image dimension, or pixel dimension, generally refers to the number of pixels in an image, which may be expressed, for example, in width multiplied by height for two-dimensional images or otherwise appropriate for relevant dimension or shape of the image. Thus, images having a native resolution may be resized to a smaller size (e.g., having smaller pixel dimensions) in order to, for example, reduce the cost of processing and analyzing the images. Filters (e.g., a non-uniformity estimate) may be generated based on an analysis of the resized images. The filters may then be resized to the native resolution and dimensions of the images, before being applied to the images.

The image interface 120 may include, in some embodiments, appropriate input ports, connectors, switches, and/or circuitry configured to interface with external devices (e.g., a remote device 150 and/or other devices) to receive images (e.g., digital image data) generated by or otherwise stored at the external devices. The received images or image data may be provided to the processing component 105. In this regard, the received images or image data may be converted into signals or data suitable for processing by the processing component 105. For example, in one embodiment, the image interface 120 may be configured to receive analog video data and convert it into suitable digital data to be provided to the processing component 105.

In some embodiments, the image interface 120 may include various standard video ports, which may be connected to a video player, a video camera, or other devices capable of generating standard video signals, and may convert the received video signals into digital video/image data suitable for processing by the processing component 105. In some embodiments, the image interface 120 may also be configured to interface with and receive images (e.g., image data) from the image capture component 115. In other embodiments, the image capture component 115 may interface directly with the processing component 105.

The control component 125 includes, in one embodiment, a user input and/or an interface device, such as a rotatable knob (e.g., potentiometer), push buttons, slide bar, keyboard, and/or other devices, that is adapted to generate a user input control signal. The processing component 105 may be configured to sense control input signals from a user via the control component 125 and respond to any sensed control input signals received therefrom. The processing component 105 may be configured to interpret such a control input signal as a value, as generally understood by one skilled in the art. In one embodiment, the control component 125 may include a control unit (e.g., a wired or wireless handheld control unit) having push buttons adapted to interface with a user and receive user input control values. In one implementation, the push buttons of the control unit may be used to control various functions of the imaging system 100, such as autofocus, menu enable and selection, field of view, brightness, contrast, noise filtering, image enhancement, and/or various other features of an imaging system or camera.

The display component 130 includes, in one embodiment, an image display device (e.g., a liquid crystal display (LCD)) or various other types of generally known video displays or monitors. The processing component 105 may be configured to display image data on the display component 130. The processing component 105 may be configured to retrieve image data from the memory component 110 and display any retrieved image data on the display component 130. The display component 130 may include display circuitry, which may be utilized by the processing component 105 to display image data. The display component 130 may be adapted to receive data directly from the image capture component 115, processing component 105, image interface 120, and/or sensing component 135, or the image data may be transferred from the memory component 110 via the processing component 105.

The sensing component 135 includes, in one embodiment, one or more sensors of various types, depending on the application or implementation requirements, as would be understood by one skilled in the art. Sensors of the sensing component 135 provide data and/or information to at least the processing component 105. In one aspect, the sensing component 135 may include a global positioning system (GPS). In one aspect, the processing component 105 may be configured to communicate with the sensing component 135. In various implementations, the sensing component 135 may provide information regarding environmental conditions, such as outside temperature, lighting conditions (e.g., day, night, dusk, and/or dawn), humidity level, specific weather conditions (e.g., sun, rain, and/or snow), distance (e.g., laser rangefinder or time-of-flight camera), and/or whether a tunnel or other type of enclosure has been entered or exited. The sensing component 135 may represent conventional sensors as generally known by one skilled in the art for monitoring various conditions (e.g., environmental conditions) that may have an effect (e.g., on the image appearance) on the image data provided by the image capture component 115.

In some implementations, the sensing component 135 (e.g., one or more sensors) may include devices that relay information to the processing component 105 via wired and/or wireless communication. For example, the sensing component 135 may be adapted to receive information from a satellite, through a local broadcast (e.g., radio frequency (RF)) transmission, through a mobile or cellular network and/or through information beacons in an infrastructure (e.g., a transportation or highway information beacon infrastructure), or various other wired and/or wireless techniques. In some embodiments, the processing component 105 can use the information (e.g., sensing data) retrieved from the sensing component 135 to modify a configuration of the image capture component 115 (e.g., adjusting a light sensitivity level, adjusting a direction or angle of the image capture component 115, adjusting an aperture, etc.).

The communication component 140 may be configured to facilitate wired and/or wireless communication over a network 155. By way of non-limiting examples, the communication component 140 may include an Ethernet connection, a wireless local area network (WLAN) component based on the IEEE 802.11 standards, a wireless broadband component, a network interface component (NIC), a mobile cellular component, a wireless satellite component, or various other types of wireless communication components including radio frequency (RF), microwave frequency (MWF), and/or infrared frequency (IRF) components configured for communication with the network 155. In one case, the communication component 140 may include an antenna coupled thereto for wireless communication purposes. In one case, the communication component 140 may be configured to interface with a Digital Subscriber Line (DSL) modem, a Public Switched Telephone Network (PSTN) modem, an Ethernet device, and/or various other types of wired and/or wireless network communication devices configured for communication with the network 155. In some cases, the communication component 140 may facilitate communication of the imaging system 100 with the network 155 and/or other networks.

The network 155 may be implemented as a single network or a combination of multiple networks. For example, in various embodiments, the network 155 may include the Internet and/or one or more intranets, landline networks, wireless-networks, and/or other appropriate types of communication networks. In another example, the network 155 may include a wireless telecommunications network (e.g., cellular phone network) configured to communicate with other communication networks, such as the Internet. As such, in various embodiments, the imaging system 100 and/or its individual associated components may be associated with a particular network link such as for example a Uniform Resource Locator (URL), an Internet Protocol (IP) address, and/or a mobile phone number.

In some embodiments, various components of the imaging system 100 may be distributed and in communication with one another over the network 155. The communication component 140 may be configured to facilitate wired and/or wireless communication among various components of the imaging system 100 over the network 155. In such embodiments, components may also be replicated if desired for particular applications of the imaging system 100. That is, components configured for same or similar operations may be distributed over a network. Further, all or part of any one of the various components may be implemented using appropriate components of the remote device 150 (e.g., a conventional digital video recorder (DVR), a computer configured for image processing, and/or other device) in communication with various components of the imaging system 100 via the communication component 140 over the network 155, if desired. Thus, for example, all or part of the processing component 105, all or part of the memory component 110, all or part of the display component 130, and/or all or part of the sensing component 135 may be implemented or replicated at the remote device 150. In some embodiments, the imaging system 100 may not include imaging sensors (e.g., image capture component 115), but instead receive images or image data from imaging sensors located separately and remotely from the processing component 105 and/or other components of the imaging system 100. It will be appreciated that many other combinations of distributed implementations of the imaging system 100 are possible, without departing from the scope and spirit of the disclosure.

Furthermore, in various embodiments, various components of the imaging system 100 may be combined and/or implemented or not, as desired or depending on the application or requirements. In one example, the processing component 105 may be combined with the memory component 110, image capture component 115, image interface 120, display component 130, sensing component 135, and/or communication component 140. In another example, the processing component 105 may be combined with the image capture component 115, such that certain functions of processing component 105 are performed by circuitry (e.g., a processor, a microprocessor, a logic device, a microcontroller, etc.) within the image capture component 115.

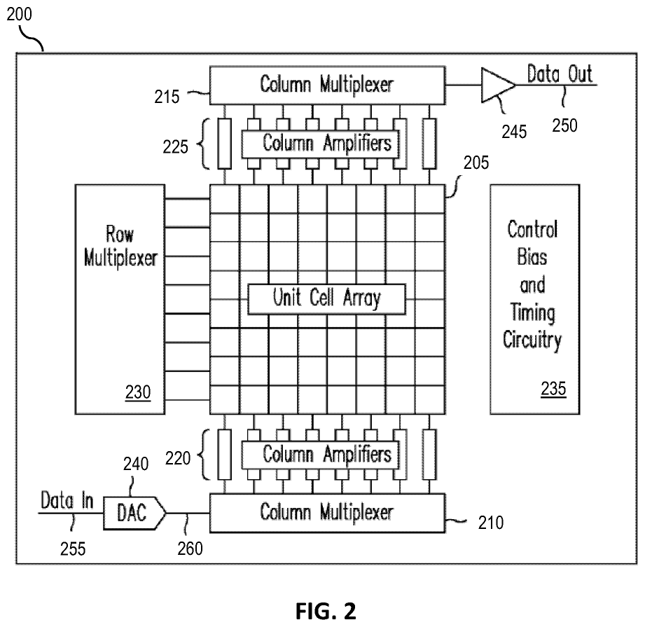

FIG. 2 illustrates a block diagram of an example image sensor assembly 200 in accordance with one or more embodiments of the present disclosure. Not all of the depicted components may be required, however, and one or more embodiments may include additional components not shown in the figure. Variations in the arrangement and type of the components may be made without departing from the spirit or scope of the claims as set forth herein. Additional components, different components, and/or fewer components may be provided. In an embodiment, the image sensor assembly 200 may be an FPA, for example, implemented as the image capture component 115 of FIG. 1.

The image sensor assembly 200 includes a unit cell array 205, column multiplexers 210 and 215, column amplifiers 220 and 225, a row multiplexer 230, control bias and timing circuitry 235, a digital-to-analog converter (DAC) 240, and a data output buffer 245. The unit cell array 205 includes an array of unit cells. In an aspect, each unit cell may include a detector and interface circuitry. The interface circuitry of each unit cell may provide an output signal, such as an output voltage or an output current, in response to a detector signal (e.g., detector current, detector voltage) provided by the detector of the unit cell. The output signal may be indicative of the magnitude of EM radiation received by the detector. The column multiplexer 215, column amplifiers 220, row multiplexer 230, and data output buffer 245 may be used to provide the output signals from the unit cell array 205 as a data output signal on a data output line 250. The output signals on the data output line 250 may be provided to components downstream of the image sensor assembly 200, such as processing circuitry (e.g., the processing component 105 of FIG. 1), memory (e.g., the memory component 110 of FIG. 1), display device (e.g., the display component 130 of FIG. 1), and/or other component to facilitate processing, storage, and/or display of the output signals. The data output signal may be an image formed of the pixel values for the image sensor assembly 200. In this regard, the column multiplexer 215, the column amplifiers 220, the row multiplexer 230, and the data output buffer 245 may collectively provide an ROIC (or portion thereof) of the image sensor assembly 200. In an embodiment, components of the image sensor assembly 200 may be implemented such that the unit cell array 205 is hybridized to (e.g., bonded to, joined to, mated to) the ROIC.

The column amplifiers 225 may generally represent any column processing circuitry as appropriate for a given application (analog and/or digital), and is not limited to amplifier circuitry for analog signals. In this regard, the column amplifiers 225 may more generally be referred to as column processors in such an aspect. Signals received by the column amplifiers 225, such as analog signals on an analog bus and/or digital signals on a digital bus, may be processed according to the analog or digital nature of the signal. As an example, the column amplifiers 225 may include circuitry for processing digital signals. As another example, the column amplifiers 225 may be a path (e.g., no processing) through which digital signals from the unit cell array 205 traverses to get to the column multiplexer 215. As another example, the column amplifiers 225 may include an ADC for converting analog signals to digital signals (e.g., to obtain digital count values). These digital signals may be provided to the column multiplexer 215.

Each unit cell may receive a bias signal (e.g., bias voltage, bias current) to bias the detector of the unit cell to compensate for different response characteristics of the unit cell attributable to, for example, variations in temperature, manufacturing variances, and/or other factors. For example, the control bias and timing circuitry 235 may generate the bias signals and provide them to the unit cells. By providing appropriate bias signals to each unit cell, the unit cell array 205 may be effectively calibrated to provide accurate image data in response to light (e.g., IR light) incident on the detectors of the unit cells.

The control bias and timing circuitry 235 may generate bias values, timing control voltages, and switch control voltages. In some cases, the DAC 240 may convert the bias values received as, or as part of, data input signal on a data input signal line 255 into bias signals (e.g., analog signals on analog signal line(s) 260) that may be provided to individual unit cells through the operation of the column multiplexer 210, column amplifiers 220, and row multiplexer 230. In another aspect, the control bias and timing circuitry 235 may generate the bias signals (e.g., analog signals) and provide the bias signals to the unit cells without utilizing the DAC 240. In this regard, some implementations do not include the DAC 240, data input signal line 255, and/or analog signal line(s) 260. In an embodiment, the control bias and timing circuitry 235 may be, may include, may be a part of, or may otherwise be coupled to the processing component 105 and/or imaging capture component 115 of FIG. 1.

In an embodiment, the image sensor assembly 200 may be implemented as part of an imaging system (e.g., the imaging system 100). In addition to the various components of the image sensor assembly 200, the imaging system may also include one or more processors, memories, logic, displays, interfaces, optics (e.g., lenses, mirrors, beamsplitters), and/or other components as may be appropriate in various implementations. In an aspect, the data output signal on the data output line 250 may be provided to the processors (not shown) for further processing. For example, the data output signal may be an image formed of the pixel values from the unit cells of the image sensor assembly 200. The processors may perform operations such as NUC, spatial and/or temporal filtering, and/or other operations. In an aspect, the processors may perform operations to facilitate calibration of the image sensor assembly 200, such as determining correction values based on a captured infrared image and temperature data associated with at least a portion of the captured infrared image. The images (e.g., processed images) may be stored in memory (e.g., external to or local to the imaging system) and/or displayed on a display device (e.g., external to and/or integrated with the imaging system).

By way of non-limiting examples, the unit cell array 205 may include 512×512 (e.g., 512 rows and 512 columns of unit cells), 1024×1024, 2048×2048, 4096×4096, 8192×8192, and/or other array sizes. In some cases, the array size may have a row size (e.g., number of detectors in a row) different from a column size (e.g., number of detectors in a column). Examples of frame rates may include 30 Hz, 60 Hz, and 120 Hz. In an aspect, each unit cell of the unit cell array 205 may represent a pixel.

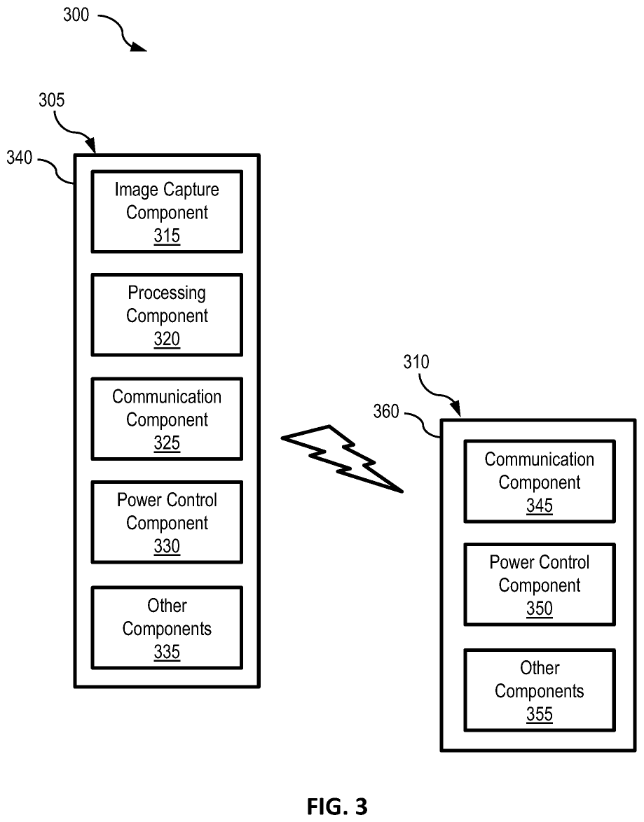

FIG. 3 illustrates a block diagram of an example thermal imaging system 300 in accordance with one or more embodiments of the present disclosure. Not all of the depicted components may be required, however, and one or more embodiments may include additional components not shown in the figure. Variations in the arrangement and type of the components may be made without departing from the spirit or scope of the claims as set forth herein. Additional components, different components, and/or fewer components may be provided.

The thermal imaging system 300 includes a thermal imaging device 305 and a receiver device 310. The thermal imaging device 305 includes an image capture component 315, a processing component 320, a communication component 325, a power control component 330, and other components 335. In an embodiment, the thermal imaging device 305 may be, may include, may be a part or, or may include components similar to those of the imaging system 100 of FIG. 1. In this regard, components of the thermal imaging device 305 may be implemented in the same or similar manner as various corresponding components of the imaging system 100.

The image capture component 315, the processing component 320, the communication component 325, the power control component 330, and other components 335 are within a housing 340 of the thermal imaging device 305. As one non-limiting example, the housing 340 may be formed of and/or may be coated with one or more materials. As an example, the housing 340 may be formed of and/or may be coated with a polymer material. The polymer material may be a plastic material such as acrylonitrile butadiene styrene (ABS) material. In one aspect, the housing 340 may be formed of, or include a portion that is formed of, a material appropriate for use as a blackbody to calibrate the image capture component 315. The housing 340 may be implemented with any desired material, shape, size to provide appropriate properties (e.g., thermal, shock/vibe, waterproofing, and aerodynamics), functionality, and/or manufacturability for a desired application(s).

The image capture component 315 captures image data of a scene (e.g., the scene 160, an external environment) and provide the image data to the processing component 320. In some cases, the image capture component 315 may process the captured images and provide the processed images to the processing component 320 (e.g., for further processing). For explanatory purposes, the image capture component 315 is utilized to capture thermal images of the scene, although in other embodiments the imaging capture component 315 may be utilized to capture data of the scene associated with other wavebands (e.g., visible-light wavebands) alternative to or in addition to the thermal infrared wavebands. In an aspect, the image capture component 315 may include one or more IR image sensors for capturing infrared images (e.g., thermal infrared images). The IR imaging sensor(s) may include an FPA implemented, for example, in accordance with various embodiments disclosed herein or others where appropriate. The IR imaging sensors may be small form factor infrared imaging devices. The IR imaging sensor(s) may be capable of detecting and capturing SWIR radiation, LWIR radiation, MWIR radiation, and/or other radiation in infrared bands (e.g., such as thermal bands) as may be desired. In one case, the IR imaging sensor(s) may capture thermal images of the scene even in complete darkness (e.g., for night vision applications).

The image capture component 315 may capture thermal images continuously, periodically, in response to an action (e.g., changing lanes or making a turning), and/or in response to user command (e.g., a user presses a button that causes the image capture component 315 to capture a thermal image). A rate at which thermal images are captured (e.g., continuously, periodically, or otherwise) may be based on application, user preferences, safety considerations (e.g., set by manufacturers, government authorities, and/or others), power considerations (e.g., less frequent thermal image capture when the image capture component 315 is low in battery), and/or other considerations.

In some cases, the image capture component 315 may include a shutter (e.g., formed of a material appropriate for use as a blackbody) that may be used to selectively block imaging sensors of the image capture component 315. The shutter may be open (e.g., does not block the imaging sensors) during normal operation, in which the image capture component 315 is used to capture image data of a scene. The shutter may be closed (e.g., blocks the imaging sensors) during a calibration operation, in which the image capture component 315 is used to capture image data of the shutter. In other cases, the image capture component 315 is shutterless.

In one embodiment, the image capture component 315 may include multiple imaging sensors (e.g., multiple IR imaging sensors) such that the imaging sensors may be utilized to capture stereoscopic thermal images and/or panoramic thermal images of the scene. In some cases, the thermal images captured by disparately positioned imaging sensors may provide situational awareness. For example, the thermal images may be used to detect objects, pedestrians, other vehicles, and so forth. Alternatively or in addition, one or more of the IR imaging sensors may provide fault tolerance by serving as backups to each other (e.g., if one of the IR imaging sensors requires fixing or replacement).

The processing component 320 processes and/or otherwise manages images captured by the image capture component 315. The processing component 320 may be implemented as any appropriate processing device as described with regard to the processing component 105 of FIG. 1. In one embodiment, the processing component 320 may receive thermal image data captured by the image capture component 315 and process the thermal images to generate user-viewable thermal images (e.g., thermograms) of the scene. The user-viewable thermal images may be visible-light representations of the captured thermal image data. The user-viewable thermal images may be provided by the processing component 320 to the communication component 325 for transmission to the receiver device 310, as further described herein. In an aspect, the processing component 320 may generate and overlay information and/or alarms (e.g., an overlaid bounding box indicating a detected object, a temperature reading, and/or others) onto the user-viewable thermal images. In some cases, the processing component 320 may receive thermal images from two or more IR imaging sensors of the image capture component 315 and combine the thermal images to generate stereoscopic user-viewable images (e.g., three dimensional thermograms) of an external environment therefrom. In some cases, when the image capture component 315 has imaging sensors for capturing image data of different waveband (e.g., visible-light and infrared wavebands), the processing component 320 may receive and combine/fuse image data from these imaging sensors.

In some aspects, processing of captured image data may be distributed between the image capture component 315, the processing component 320, and/or the other components 335. For example, in some cases, the processing component 320 and/or the image capture component 315 may perform automatic exposure control (e.g., by controlling signal gain, camera aperture, and/or shutter speed) on the image capture component 315 to adjust to changes in the infrared intensity and temperature level of the scene.

The communication component 325 may handle communication between various components of the thermal imaging device 305 and between the thermal imaging device 305 and the receiver device 310. The communication component 325 may facilitate wired and/or wireless connections. In some embodiments, the communication component 325 handles communication with devices external to the thermal imaging device 305, such as the receiver device 310. For example, the communication component 325 may transmit user-viewable images to the receiver device 310 and/or other devices. In some cases, the communication component 325 wirelessly communicates with the receiver device 310 and/or other devices. In addition, components such as the image capture component 315 and the processing component 320 may transmit data to and receive data from each other via the communication component 325. By way of non-limiting examples, such connections may be provided using inter-chip connections, intra-chip connections, proprietary RF links, Universal Serial Bus (USB) connections, embedded USB (eUSB) connections, and/or standard wireless communication protocols (e.g., IEEE 802.11 WiFi standards, and Bluetooth™) between the various components.

The power control component 330 (e.g., also referred to as a power regulation component or a power management component) may be connected to the receiver device 310, the image capture component 315, the processing component 320, the communication component 325, and the other components 335. In one embodiment, the power control component 330 may receive wireless power (e.g., via inductive power transmission, capacitive power transmission, and/or other wireless power transmission) from the receiver device 310. As an example, the power control component 330 may include or may be coupled to a wireless power Qi receiver that receives wirelessly transmitted power from a wireless power Qi transmitter of the receiver device 310. In some cases, the power management device 330 may include one or more power sources (e.g., rechargeable batteries, non-rechargeable batteries) and associated circuitry for controlling power provided by the power source(s) to components of the thermal imaging device 305.

The other components 335 of the thermal imaging device 305 may be used to implement any features of the system 300 as may be desired for various applications. By way of non-limiting examples, the other components 265 may include a GPS, a memory, various sensors (e.g., motion sensor), timers, a flashlight, a visible light camera, and/or others.

In one aspect, the other components 335 may represent reference objects for calibration. As non-limiting examples, the reference object may be positioned within the housing 340 or provided by a portion (e.g., a surface) of the housing 340. The reference object may include a surface of the housing 340 that may be formed of a material appropriate for use as a blackbody). In some cases, a portion of the housing 340 may provide a shutter that may selectively block imaging sensors of the image capture component 315 (e.g., by blocking an aperture of the housing 340 that receives light from the scene). The shutter may be open (e.g., does not block the imaging sensors) during normal operation, in which the image capture component 315 is used to capture image data of a scene. The shutter may be closed (e.g., blocks the imaging sensors) during a calibration operation, in which the image capture component 315 is used to capture image data of the shutter. The reference object may include an object secured within the housing 340 that may be imaged by the image capture component 315 (e.g., during calibration).

It is noted that in some cases the thermal imaging device 305 does not provide any blackbody for facilitating calibration of the image capture component 315. In such cases, the thermal imaging device 305 may calibrate using reference objects in a scene, such as the road, surfaces of buildings, surfaces of a vehicle (e.g., such as the vehicle to which the thermal imaging device 305 is mounted), an ornament on the vehicle, and/or others. Examples of calibration of image sensors of an imaging device mounted on a vehicle based on objects external to the imaging device are provided in International Publication No. WO 2021/142164, entitled “Radiometric Calibration Systems for Infrared Imagers,” which is incorporated herein by reference in its entirety. In some cases, use of reference objects provided external to the housing 340 and/or provided by or within the housing 340 for calibration rather than a shutter provided by the image capture component 315 allows avoiding of instantaneous power associated with operation of such a shutter.

The receiver device 310 includes a communication component 345, a power control component 350, and other components 355. In an embodiment, the receiver device 310 may be, may include, may be a part or, or may include components similar to those of the imaging system 100 of FIG. 1. In this regard, components of the receiver device 310 may be implemented in the same or similar manner as various corresponding components of the imaging system 100.

The communication component 345, the power control component 350, and other components 355 are within a housing 360 of the receiver device 310. As one non-limiting example, the housing 340 may be formed of and/or may be coated with one or more materials. As an example, the housing 340 may be formed of and/or may be coated with a polymer material. The polymer material may be a plastic material such as ABS material.

The communication component 345 may handle communication between various components of the receiver device 310 and between the thermal imaging device 305 and the receiver device 310. The communication component 345 may facilitate wired and/or wireless connections. In some embodiments, the communication component 345 handles communication with devices external to the thermal imaging device 305, such as a user device (e.g., smartphone, laptop, tablet). For example, the communication component 345 may transmit user-viewable images received from the communication component 325 to the user device. By way of non-limiting examples, such connections may be provided using inter-chip connections, intra-chip connections, proprietary RF links, USB connections, eUSB connections, and/or standard wireless communication protocols (e.g., IEEE 802.11 WiFi standards, and Bluetooth™) between the various components. In some cases, the communication component 345 may facilitate communication with a controller area network (CAN).

The power control component 350 (e.g., also referred to as a power regulation component or a power management component) may be connected to the thermal image device 305, the communication component 345, and the other components 355. The power control component 350 may receive power from an external power source. For example, the external power source may be a vehicle battery, a charging device, an electrical wall outlet (e.g., connected via a standard cable adapter), a charging cradle, and/or other power source. The power control component 350 may transmit wireless power (e.g., via inductive power transmission, capacitive power transmission, and/or other wireless power transmission) to the thermal imaging device 305. As an example, the power control component 350 may include or may be coupled to a wireless power Qi transmitter that transmits wireless power to the thermal imaging device 305. In some cases, the power control component 350 may include one or more power sources (e.g., rechargeable batteries, non-rechargeable batteries) and associated circuitry for controlling power provided by the power source(s) to components of the receiver device 310.

The other components 355 of the receiver device 310 may be used to implement any features of the system 300 as may be desired for various applications. By way of non-limiting examples, the other components 355 may include a GPS, a memory, various sensors (e.g., motion sensor), timers, a flashlight, and/or others. In some cases, the other components 355 may include a display device to display the user-viewable thermal images, alternative or in addition to streaming the user-viewable thermal images to a user device for processing, display, and/or storage.

Although the thermal imaging system 300 includes a single thermal imaging device and a single receiver device, a thermal imaging system may include multiple thermal imaging devices and/or multiple receiver devices. Each thermal imaging device may communicate with one or more receiver devices. In some cases, the multiple receiver devices may be used as a repeater to facilitate relay of the image data to a user device. Each receiver device may communicate with one or more user devices.

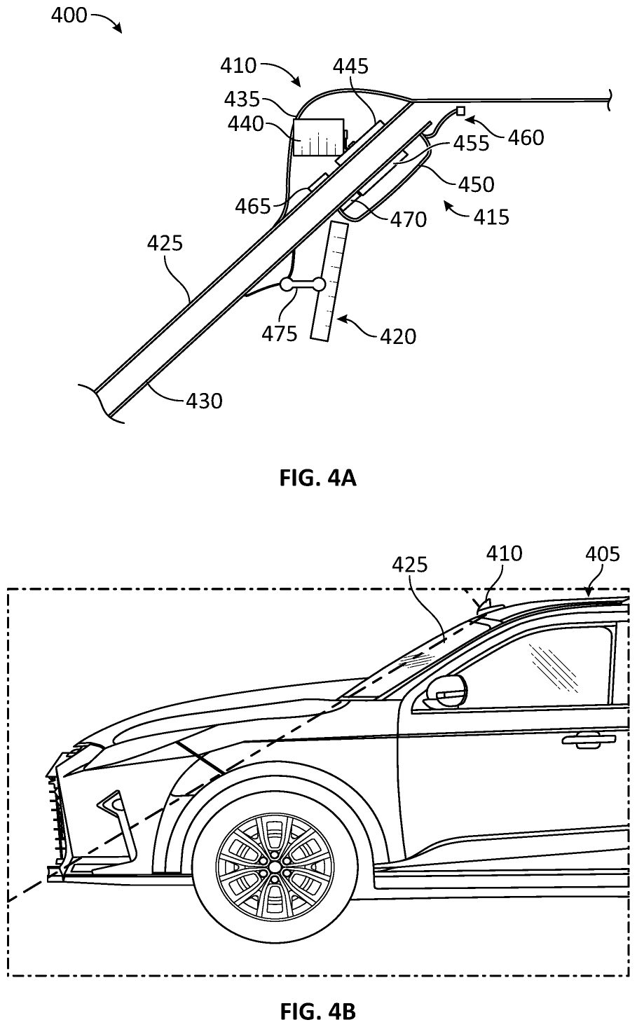

FIG. 4A illustrates an example system 400 (e.g., also referred to as an environment, a vehicular system, or a vehicular environment) for facilitating thermal imaging and wireless communication in accordance with one or more embodiments of the present disclosure. FIG. 4B illustrates a zoomed-out view that illustrates a vehicle 405 and a portion of the system 400 exterior to the vehicle 405. The system 400 includes a thermal imaging device 410, a receiver device 415 (e.g., also referred to as a receiver box), and a user device 420. The thermal imaging device 410 and the receiver device 415 are coupled (e.g., mounted) to an exterior surface 425 and an interior surface 430, respectively, of a windshield.

The thermal imaging device 410 includes a housing 435, an imaging component 440 within the housing 435, and a circuit assembly 445 (e.g., printed circuit board assembly (PCBA)) within the housing 435. In some embodiments, the thermal imaging device 410 may be, may include, or may be a part of, the thermal imaging device 305 of FIG. 3. As such, the description of the various components of the thermal imaging device 305 of FIG. 3 generally applies to the thermal imaging device 410 of FIGS. 4A and 4B.

The imaging component 440 has an FOV to capture a thermal infrared image data of a scene external to and in front of the vehicle 405. The imaging component 440 may process the thermal infrared image data to generate user-viewable thermal images of the scene. The image component 440 may provide the user-viewable thermal images to the circuit assembly 445. The circuit assembly 445 may include a transceiver circuit for receiving the user-viewable thermal images from the imaging component 440 and transmitting (e.g., wirelessly transmitting) the user-viewable thermal images to the receiver device 415. In some cases, the transceiver circuit may support short-range communications (e.g., over a gap of a few centimeters) to allow transmission of the user-viewable thermal images through the windshield to the receiver device 415. The circuit assembly 445 may also include a power control circuit for receiving power (e.g., wirelessly receiving power) from the receiver device 415. In some cases, the power control circuit may receive power from an external power source, such as for charging the thermal imaging device 410 when the thermal imaging device 410 is not operating or in applications that the thermal imaging device 410 can be readily charged (e.g., with a cable) during operation. In some cases, the thermal imaging device 410 may include batteries that may be charged by the receiver device 415 and/or an external power source. For example, the external power source may be a charging device, an electrical wall outlet (e.g., connected via a standard cable adapter), a charging cradle, and/or other power source. The received power may be distributed to components of the circuit assembly 445 and the imaging component 440. In some embodiments, the imaging component 440 may implement functionality of the image capture component 315 and the processing component 320 of FIG. 3, and/or the circuit assembly 445 may implement functionality of the processing component 320, the communication component 325, and the power control component 330 of FIG. 3.

The receiver device 415 has a housing 450 and a circuit assembly 455 (e.g., PCBA). The circuit assembly 455 may include a transceiver circuit for receiving (e.g., wirelessly receiving) the user-viewable thermal images from the circuit assembly 445 of the thermal imaging device 410 and transmitting the user-viewable thermal images to the user device 420. The transceiver circuit may transmit the user-viewable thermal images to the user device 420 via wireless transmission (e.g., Wi-Fi) and/or via wired connection (e.g., wired USB connection). The transceiver circuit interfaces with one or more optional cables 460 extending from the receiver device 415. The cable(s) 460 may represent a USB cable for connecting to the user device 420 and/or a CAN bus cable (e.g., RJ45 or comparable shielded twisted-pair (STP) cable) for connecting to on-board diagnostics (OBD)-II connector. The circuit assembly 455 may also include a power control circuit for receiving power from an external power source (e.g., for charging the receiver device 415) and for transmitting power (e.g., wirelessly transmitting power) to the thermal imaging device 410. As an example, the external power source may be a car battery. In this regard, the power may be distributed to components of the circuit assembly 455 and the thermal imaging device 410. In some cases, the receiver device 415 may include batteries that may be charged from an external power source. In some embodiments, the circuit assembly 455 may implement functionality of the communication component 345, the power control component 350, and/or the other components 355 of FIG. 3.

The user device 420 may be a smartphone, a tablet, a laptop, or generally any device that may receive the user-viewable thermal images from the receiver device 415. The user device 420 may include an appropriate processing component, display component, and memory to process, display, and/or store the user-viewable thermal images. In some cases, the user device 420 may have an application installed thereon for facilitating navigation of the vehicle 405 using the user-viewable thermal images. The application may help guide a human driver and/or facilitate autonomous driving. As a non-limiting example, the application may use the user-viewable thermal images to identify objects (e.g., cars, pedestrians) in a scene and generate a warning (e.g., a visual alert, an audible alert) for the driver of the vehicle 405 and/or for the vehicle 405. Although in FIG. 4A the user device 420 is a portable device coupled to the vehicle 405, the user device 420 may be a device integrated in the vehicle 405.

One or more engagement elements 465 may include metal, magnets, adhesives (e.g., glue, tape), suction cups, and/or generally any fasteners and/or fastening structure that can securely and releasably couple the thermal imaging device 410 to the exterior surface 425 of the windshield of the vehicle 405. Although the engagement element(s) 465 is shown within the housing 435, the engagement element(s) 465 may alternatively or in addition be external to the housing 435. The engagement element(s) 465 may be provided as part of the thermal imaging device 410 and/or a separate component(s) to facilitate such physical coupling of the thermal imaging device 410 to the vehicle 405.

One or more engagement elements 470 and 475 may include metal, magnets, adhesives (e.g., glue, tape), suction cups, and/or generally any fasteners and/or fastening structure that can securely and releasably couple the receiver device 415 to the interior surface 430 of the windshield of the vehicle 405. Although the engagement element(s) 470 is shown within the housing 450, the engagement element(s) 470 may alternatively or in addition be external to the housing 450. In some aspects, the engagement element(s) 465 and 470 may be appropriately aligned to facilitate coupling of the thermal imaging device 410 and the receiver device 415. As an example, the engagement element(s) 465 and 470 may include a magnet provided proximate to the thermal imaging device 410 and the receiver device 415 that attract each other. The engagement element(s) 470 may be provided as part of the receiver device 415 and/or a separate component(s) to facilitate such physical coupling of the receiver device 415 to the vehicle 405. The engagement element(s) 475 may be provided as part of the user device 420 and/or a separate component(s) to facilitate such physical coupling of the user device 420 to the vehicle 405. In FIG. 4A, the thermal imaging device 410 and the receiver device 415 face each other and are separated by a thickness of the windshield.

It is noted that the system 400 provides one example for mounting the thermal imaging device 410, the receiver device 415, and the user device 420 to the vehicle 405. Other manners by which to mount the thermal imaging device 410, the receiver device 415, and the user device 420 may be used dependent on application and capabilities. As an example, the thermal imaging device 410 may be secured via coupling to a bottom, metal portion of the roof of a vehicle 405 adjacent to the windshield. The thermal imaging device 410 may be positioned such that it partially faces the bottom, metal portion of the roof as well as an upper portion of the windshield to allow wireless transmission through the windshield. As another example, the thermal imaging device 410 may be coupled (e.g., at least partially coupled) to a glass roof of a vehicle. In any of these examples, the receiver device 415 may be positioned at any location appropriate to receive wireless transmissions from the thermal imaging device 410. As an example, in cases where wireless communication over a longer distance can be effectuated, the receiver device 415 may be placed on any surface within the vehicle 405 rather than mounted.

More generally, the thermal imaging device 410 may be positioned along any exterior surface or location of the vehicle 405, such as on a grille of the vehicle 405, on a right or a left side A-pillar, near the rear-view mirror of the vehicle 405, and/or other positions, appropriate to securely maintain the thermal imaging device 410 and capture a desired FOV while not having its FOV blocked by material (e.g., windshield) that attenuates infrared radiation and while being in compliance with any regulations/laws (e.g., local windshield obstruction laws). In some cases, a position of the thermal imaging device 410, the receiver device 415, and/or the user device 420 may be selected by the user.

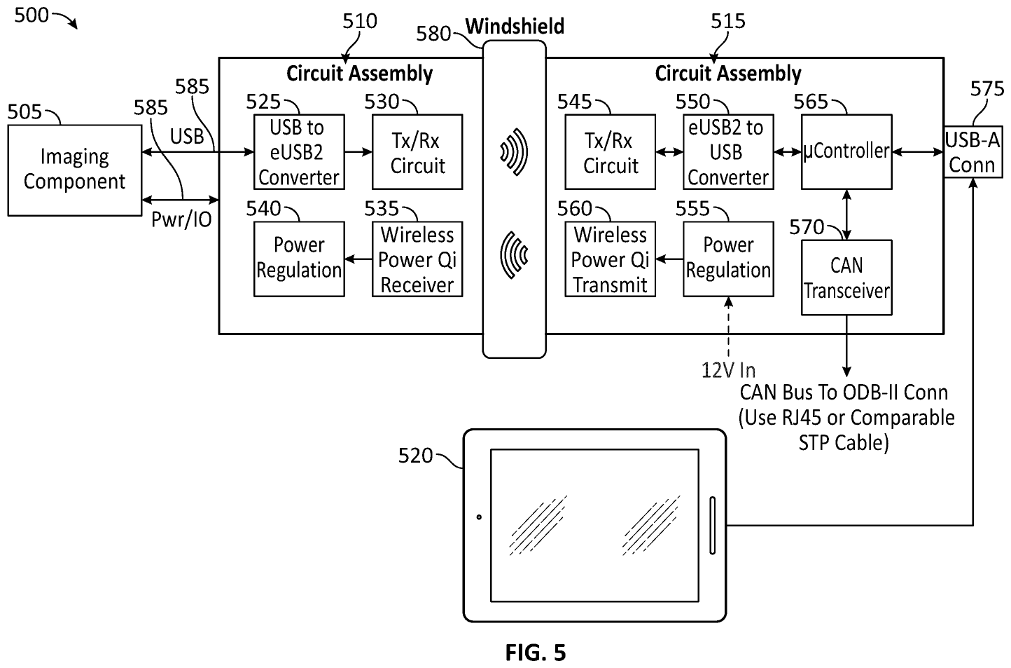

FIG. 5 illustrates a block diagram of an example system 500 for facilitating thermal imaging and wireless communication in accordance with one or more embodiments of the present disclosure. Not all of the depicted components may be required, however, and one or more embodiments may include additional components not shown in the figure. Variations in the arrangement and type of the components may be made without departing from the spirit or scope of the claims as set forth herein. Additional components, different components, and/or fewer components may be provided. The description of FIGS. 4A and 4B generally apply to FIG. 5, with examples of differences between FIGS. 4A-4B and FIG. 5 and other description provided herein.

The system 500 includes an imaging component 505, a circuit assembly 510, a circuit assembly 515, and a user device 520. In some embodiments, the imaging component 505, the circuit assembly 510, the circuit assembly 515, and the user device 520 may be, may include, or may be a part of the imaging component 440, the circuit assembly 445, the circuit assembly 455, and the user device 420, respectively. In this regard, the imaging component 505 and the circuit assembly 510 may be within a housing (not shown in FIG. 5) coupled to a windshield 580 of a vehicle, and the circuit assembly 515 may be within a housing (not shown in FIG. 5) coupled to the windshield 580 (e.g., coupled to a surface of the windshield 580 opposite a surface to which the housing of the imaging component 505 and the circuit assembly 510 is coupled).

The imaging component 505 may capture thermal image data and generate images (e.g., user-viewable thermal images). The images may be transmitted via a USB connection to a USB-to-eUSB2 converter 525 of the circuit assembly 510. The USB-to-eUSB2 converter 525 converts the images to a corresponding eUSB2 output signal (e.g., a signal according to a eUSB2 protocol and including data indicative of the images) and transmits the eUSB2 output signal to a transceiver circuit 530. The transceiver circuit 530 wirelessly transmits the images (e.g., as a eUSB2 signal) to a transceiver circuit 545 of the circuit assembly 515. The transceiver circuit 545 transmits the images (e.g., as a eUSB2 signal) to a eUSB2-to-USB converter 550. The eUSB2-to-USB converter 550 converts the eUSB2 signal to a USB signal corresponding to the images. In FIG. 5, the eUSB2-to-USB converter 550 transmits the USB signal to an optional microcontroller 565. The microcontroller 565 may be used to optionally process the images prior to transmission to the user device via a USB connection 575. The microcontroller 565 may also communicate with an optional CAN transceiver circuit 570. The CAN transceiver circuit 570 may facilitate communication between a CAN bus and an ODB-II connection (e.g., using RJ45 or comparable STP cable). In some cases, the eUSB2-to-USB converter 550 transmits the USB signal directly to the user device 520 via the USB connection 575 (e.g., without transmitting to the optionally intervening microcontroller 565).

As an example, the transceiver circuits 530 and 545 may include an ST60A3 chip operating in USB mode. The ST60A3 utilizes 60 GHz wireless transceiver technology and facilitates short-range connectivity (e.g., up to around 6 cm) through air, glass, wood, and other non-conductive materials. A data link formed using the ST60A3 may be used to pass, for example, Ethernet and USB data. The ST60A3 may be leveraged for its built-in native support for eUSB2, which is designed for modern process nodes with lower bias rails. Its half-duplex operation may allow both video streaming for the down link and camera control on the up link. As an example, the microcontroller may include an STM32 chip with USB support. It is noted that the system 500 provides one non-limiting example that utilizes USB and eUSB signals and associated conversions and that other implementations may or may not utilize such signals and associated conversions.

The circuit assembly 515 also includes a power control circuit 555 and a wireless power Qi transmit component 560. The power control circuit 555 may receive power from an external power source and distribute the power within the circuit assembly 515 and to the circuit assembly 510. As an example, the external power source may be a 12 V from a car battery. The wireless power Qi transmit component 560 may inductively transmit power to the circuit assembly 510. The circuit assembly 510 also includes a wireless power Qi receive component 535 and a power control circuit 540. The wireless power Qi receive component 535 inductively receives the power from the wireless power Qi transmit component 560. The power control circuit 540 may receive power from the wireless power Qi receive component 535 and distribute the power within the circuit assembly 510 and, via a power connection 585, to the imaging component 505. Thus, using various embodiments, video data may be captured by an imaging component and streamed (e.g., across a windshield in some cases) to a user device via appropriate circuit assemblies. Components associated with such imaging may be powered at least in part through wireless power transfer.

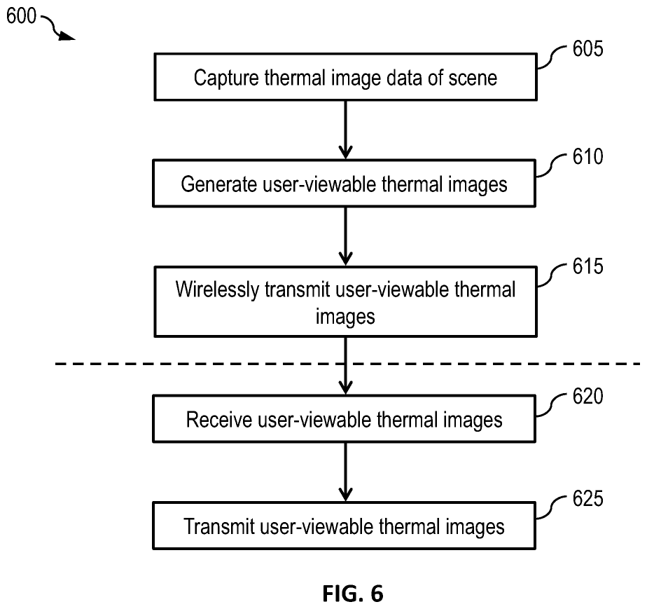

FIG. 6 illustrates a flow diagram of an example process 600 for facilitating thermal imaging and wireless communication in accordance with one or more embodiments of the present disclosure. For explanatory purposes, the process 600 is primarily described herein with reference to the system 400 of FIG. 4. However, the example process 600 is not limited the system 400. Note that one or more operations in FIG. 6 may be combined, omitted, and/or performed in a different order as desired.

At block 605, the thermal imaging device 410 captures thermal image data of a scene (e.g., the scene 160). The thermal imaging device 410 is mounted on the vehicle 405. The thermal image data may include pixel values, where each pixel value is associated with an infrared sensor of the array. In the thermal image data, each pixel value represents a temperature of a corresponding portion of the scene. At block 610, the thermal imaging device 410 generates user-viewable thermal images based on the thermal image data. At block 615, the thermal imaging device 410 wirelessly transmits the user-viewable thermal images. With reference to FIG. 4B, the thermal imaging device 410 may wirelessly transmit the user-viewable thermal images across the windshield of the vehicle 405 and to the receiver device 415. At block 620, the receiver device 415 receives the user-viewable thermal images from the thermal imaging device. At block 625, the receiver device 415 transmits (e.g., wirelessly and/or wired transmission) the user-viewable thermal images to the user device 420. In some cases, the receiver device 415 may wirelessly transmit power to the thermal imaging device 410. With reference to FIG. 4B, the receiver device 415 may wirelessly transmit the power across the windshield of the vehicle 405 and to the thermal imaging device 410.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice versa.

Software in accordance with the present disclosure, such as non-transitory instructions, program code, and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

The foregoing description is not intended to limit the present disclosure to the precise forms or particular fields of use disclosed. Embodiments described above illustrate but do not limit the invention. It is contemplated that various alternate embodiments and/or modifications to the present invention, whether explicitly described or implied herein, are possible in light of the disclosure. Accordingly, the scope of the invention is defined only by the following claims.

What is claimed is:

1. A thermal imaging system comprising:
a thermal imaging device configured to:
capture thermal image data associated with a scene;
generate user-viewable thermal images based on the thermal image data; and
wirelessly transmit data indicative of the user-viewable thermal images; and
a receiver device configured to:
receive the data from the thermal imaging device; and
transmit the data to a user device.

2. The thermal imaging system of claim 1, wherein the receiver device is configured to wirelessly transmit power to the thermal imaging device.

3. A vehicular system comprising the thermal imaging system of claim 2, the vehicular system further comprising:
a vehicle, wherein the thermal imaging device is coupled to an exterior surface of the vehicle and configured to wirelessly transmit the data into an interior of the vehicle and to the receiver device, and wherein the receiver device is coupled to an interior surface of the vehicle or positioned inside the vehicle and configured to wirelessly transmit the power outside of the vehicle and to the thermal imaging device.

4. The thermal imaging system of claim 1, wherein the thermal imaging device is configured to wirelessly transmit the data through a windshield to the receiver device.

5. The thermal imaging system of claim 1, wherein the thermal imaging device comprises a housing, an image capture component within the housing and configured to capture the thermal image data, a processing component within the housing and configured to generate the user-viewable thermal images, and a communication component within the housing configured to transmit the data.

6. The thermal imaging system of claim 5, wherein the thermal imaging device further comprises a power control circuit configured to wirelessly receive power from the receiver device.

7. The thermal imaging system of claim 5, wherein the data comprise one or more embedded universal serial bus (USB) signals.

8. The thermal imaging system of claim 7, wherein:
the thermal image device further comprises a first converter coupled to the processing component and the communication component;
the first converter is configured to:
receive the user-viewable thermal images via a universal serial bus (USB) connection;
convert the user-viewable thermal images to the one or more embedded USB signals; and
transmit the one or more embedded USB signals to the communication component.

9. The thermal imaging system of claim 8, wherein the receiver device comprises a second converter configured to:
receive the one or more embedded USB signals;
convert the one or more embedded USB signals to one or more USB signals indicative of the user-viewable thermal images;
transmit the one or more USB signals to the user device via a USB connection.

10. The thermal imaging system of claim 1, wherein the thermal imaging device is configured to couple to an exterior surface of a vehicle.

11. The thermal imaging system of claim 10, wherein the receiver device is configured to couple to an interior surface of the vehicle or configured to be positioned inside the vehicle.

12. A vehicular system comprising the thermal imaging system of claim 10, the vehicular system comprising:
the vehicle comprising a windshield, wherein the thermal imaging device is coupled to an exterior surface of the windshield, wherein the receiver device is coupled to an interior surface of the windshield opposite the exterior surface of the windshield, wherein the thermal imaging device is configured to wirelessly transmit the data to the receiver device through the windshield, and wherein the receiver device is configured to wirelessly transmit power to the thermal imaging device through the windshield.

13. The vehicular system of claim 12, wherein the thermal imaging device faces the receiver device.

14. A method comprising:
capturing, by a thermal imaging device, thermal image data associated with a scene;
generating, by the thermal imaging device, user-viewable thermal images based on the thermal image data;
wirelessly transmitting, by the thermal imaging device, data indicative of the user-viewable thermal images;
receiving, by a receiver device, the data from the thermal imaging device; and
transmitting, by the receiver device, the data to a user device.

15. The method of claim 14, further comprising wirelessly transmitting, by the receiver device, power to the thermal imaging device, wherein the thermal imaging device is coupled to an exterior surface of a vehicle, wherein the receiver device is coupled to an interior surface of the vehicle or positioned inside the vehicle, wherein the data are wirelessly transmitted by the thermal imaging device into an interior of the vehicle and to the receiver device, and wherein the power is wirelessly transmitted, by the receiver device, outside of the vehicle and to the thermal imaging device.

16. The method of claim 14, wherein the data are wirelessly transmitted, by the thermal imaging device, through a windshield to the receiver device.

17. The method of claim 14, wherein the thermal imaging device is coupled to an exterior surface of a vehicle.

18. The method of claim 17, wherein the receiver device is coupled to an interior surface of the vehicle or positioned inside the vehicle.

19. The method of claim 17, wherein:
the thermal imaging device is coupled to an exterior surface of a windshield of the vehicle,
the receiver device faces the thermal imaging device and is coupled to an interior surface of the windshield opposite the exterior surface of the windshield;
the data are wirelessly transmitted by the thermal imaging device through the windshield to the receiver device; and
power is wirelessly transmitted by the receiver device through the windshield to the thermal imaging device.

20. The method of claim 14, further comprising converting, by the thermal imaging device, the user-viewable thermal images to one or more embedded universal serial bus (USB) signals, wherein the data indicative of the user-viewable thermal images comprise the one or more embedded USB signals.
